(19) United States
(12) Patent Application Publication
(10) Pub. No.: US 2026/0312788 A1
(43) Pub. Date: Oct. 8, 2026

(54) PRIVACY PROTECTION SYSTEM AND METHOD, MEDIUM, AND DEVICE

(71) Applicant: Advanced Nova Technologies (Singapore) Holding Pte. Ltd., Singapore (SG)

(72) Inventor: Zhe Han, Hangzhou (CN)

(73) Assignee: Advanced Nova Technologies (Singapore) Holding Pte. Ltd., Singapore (SG)

(21) Appl. No.: 19/436,922

(22) Filed: Dec. 30, 2025

(30) Foreign Application Priority Data
Apr. 2, 2025 (SG) 10202500868U

(51) Int. Cl. H04L 9/00; H04L 9/32

(52) U.S. Cl. CPC H04L 9/008; H04L 9/3218; H04L 9/50

(57) ABSTRACT

This specification discloses systems, methods, media and devices for privacy protection, which are applied to a blockchain. An example system includes a first terminal, a second terminal, and a consensus node. The first terminal determines first service data, performs homomorphic encryption on the first service data to obtain first ciphertext, and performs asymmetric encryption on the first service data based on a public key of the second terminal to obtain second ciphertext; generates a first zero-knowledge proof proving that the second ciphertext matches the first service data, and constructs a service data packet based on the first ciphertext, the second ciphertext, and the first zero-knowledge proof; and invokes a smart contract to verify the service data packet, and when the verification succeeds, sends the service data packet to the consensus node by using the smart contract.

### CROSS-REFERENCE TO RELATED APPLICATIONS

This application claims priority to Singapore Patent Application No. 10202500868U, filed on Apr.2, 2025, which is hereby incorporated by reference in its entirety.

### TECHNICAL FIELD

This specification relates to the field of computer technologies, and in particular, to a privacy protection system and method, a medium, and a device.

### BACKGROUND

With the rapid development of the blockchain technology, core features of the blockchain technology, that is, a distributed ledger and decentralization, provide unprecedented transparency for financial services. However, this transparency causes a security problem to user privacy. Therefore, to ensure security of private service data such as a service amount and a product quantity, a homomorphic encryption technology is usually used to encrypt the service data.

In an existing homomorphic encryption privacy protection solution based on a zero-knowledge proof, for example, a note model using Zcash currency as an example, a core feature of the solution is that transaction data can be anonymous, that is, a sender, a receiver, and an amount of a transaction can be hidden, and can be viewed only by a transaction participant that has a corresponding view key. This manner allows validity of the transaction to be verified through a zero-knowledge proof without disclosing two transaction parties and a transaction amount.

However, in this manner, when the entire transaction is private, a process in which a receiver of the transaction decrypts service data obtained after homomorphic encryption, for example, a transaction amount, is complex and consumes relatively long time, which makes it difficult to quickly determine the transaction amount. Therefore, the receiver of the transaction cannot immediately determine whether the transaction is normally completed, which results in poor experience of the transaction participants and reduces a probability that the transaction is normally completed.

Therefore, this specification provides a privacy protection system and method, a medium, and a device.

### SUMMARY

This specification provides a privacy protection system and method, a medium, and a device, to at least partially resolve the above-mentioned problems in the conventional technology.

This specification provides a privacy protection system. The system is applied to a blockchain, and includes a first terminal, a second terminal, and a consensus node. The first terminal is configured to: determine first service data of a to-be-executed service, perform homomorphic encryption on the first service data to obtain first ciphertext, where the first ciphertext is used to execute the to-be-executed service, encrypt the first service data based on a public key of the second terminal to obtain second ciphertext, and generate a first zero-knowledge proof proving that the second ciphertext matches the first service data; construct a service data packet based on the first ciphertext, the second ciphertext, and the first zero-knowledge proof; and send the service data packet to the consensus node. The consensus node is configured to: receive the service data packet, and perform consensus on the to-be-executed service based on the service data packet. The second terminal is configured to: obtain, from the blockchain in response to a query operation, the service data packet obtained after the to-be-executed service has passed consensus, and decrypt the second ciphertext in the service data packet based on a private key of the second terminal to determine the first service data.

This specification provides a privacy protection method. The method is applied to a first terminal in a privacy protection system. The privacy protection system is applied to a blockchain, and the privacy protection system includes the first terminal, a second terminal, and a consensus node. The method includes: determining first service data of a to-be-executed service, performing homomorphic encryption on the first service data to obtain first ciphertext, where the first ciphertext is used to execute the to-be-executed service, encrypting the first service data based on a public key of the second terminal to obtain second ciphertext, and generating a first zero-knowledge proof proving that the second ciphertext matches the first service data; constructing a service data packet based on the first ciphertext, the second ciphertext, and the first zero-knowledge proof; and sending the service data packet to the consensus node, so that the second terminal obtains, from the blockchain through a query operation, the service data packet obtained after the to-be-executed service has passed consensus, and decrypts the second ciphertext in the service data packet to determine the first service data.

This specification provides a privacy protection method. The method is applied to a second terminal in a privacy protection system. The privacy protection system is applied to a blockchain, and the privacy protection system includes a first terminal, the second terminal, and a consensus node. The method includes: obtaining, from the blockchain in response to a query operation, a service data packet obtained after a to-be-executed service has passed consensus; and decrypting second ciphertext in the service data packet based on a private key of the second terminal to determine first service data.

This specification provides a computer system. The computer system is applied to a first terminal in a privacy protection system. The privacy protection system is applied to a blockchain, and the privacy protection system includes the first terminal, a second terminal, and a consensus node. The computer system includes a memory, a processor, and a computer program that is stored in the memory and that is capable of running on the processor. The processor executes the program to implement the following steps: determining first service data of a to-be-executed service, performing homomorphic encryption on the first service data to obtain first ciphertext, where the first ciphertext is used to execute the to-be-executed service, encrypting the first service data based on a public key of the second terminal to obtain second ciphertext, and generating a first zero-knowledge proof proving that the second ciphertext matches the first service data; constructing a service data packet based on the first ciphertext, the second ciphertext, and the first zero-knowledge proof; and sending the service data packet to the consensus node, so that the second terminal obtains, from the blockchain through a query operation, the service data packet obtained after the to-be-executed service has passed consensus, and decrypts the second ciphertext in the service data packet to determine the first service data.

This specification provides a computer system. The computer system is applied to a second terminal in a privacy protection system. The privacy protection system is applied to a blockchain, and the privacy protection system includes a first terminal, the second terminal, and a consensus node. The computer system includes a memory, a processor, and a computer program that is stored in the memory and that is capable of running on the processor. The processor executes the program to implement the following steps: obtaining, from the blockchain in response to a query operation, a service data packet obtained after a to-be-executed service has passed consensus; and decrypting second ciphertext in the service data packet based on a private key of the second terminal to determine first service data.

This specification provides a computer-readable nonvolatile storage medium. The storage medium stores a computer program, and when the computer program is executed by a processor, the above-mentioned privacy protection method is implemented.

At least one of the above-mentioned technical solutions used in the implementations of this specification can achieve at least one of the following beneficial effects: Homomorphic encryption is performed on the service data of the to-be-executed service, so that privacy protection can be performed on the service data of the to-be-executed service between the first terminal and the second terminal. The service data is encrypted by using the key of the second terminal, so that the second terminal can decrypt the service data of the to-be-executed service, thereby ensuring that the service is executable. The zero-knowledge proof is further used to ensure consistency between the second ciphertext and the first service data, so that the service data that is of the to-be-executed service and that can be decrypted by the second terminal is trusted. Even if the first ciphertext obtained after homomorphic encryption is not successfully decrypted, execution of the to-be-executed service is not affected.

### BRIEF DESCRIPTION OF DRAWINGS

The accompanying drawings described herein are used to provide a further understanding of this specification and constitute a part of this specification. The example implementations of this specification and descriptions thereof are used to explain this specification, and do not constitute an improper limitation on this specification.

FIG. 1 is a schematic diagram of a structure of a privacy protection system according to an implementation of this specification.

FIG. 2 is an interaction flowchart of a privacy protection system according to this specification.

FIG. 3 is a schematic diagram of a structure of a privacy protection system including a smart contract according to this specification.

FIG. 4 is an interaction flowchart of a privacy protection system including a smart contract according to this specification.

FIG. 5 is a schematic diagram of a structure of a privacy protection system including a regulatory authority according to this specification.

FIG. 6 is an interaction flowchart of a privacy protection system in currency payment according to this specification.

FIG. 7 is a schematic diagram of a transaction data packet according to this specification.

FIG. 8 is a schematic diagram of a transaction data packet of a user terminal according to this specification.

FIG. 9 is a schematic diagram of a transaction data packet of an issuing institution terminal according to this specification.

FIG. 10 is a schematic diagram of a transaction data packet of a supervisory node according to this specification.

FIG. 11 is a schematic flowchart of a privacy protection method applied to a first terminal in a privacy protection system according to this specification.

FIG. 12 is a schematic flowchart of a privacy protection method applied to a second terminal in a privacy protection system according to this specification.

FIG. 13 is a schematic diagram of a structure of a computer system according to an implementation of this specification.

### DETAILED DESCRIPTION

To make the objectives, technical solutions, and advantages of this specification clearer, the following clearly and comprehensively describes the technical solutions of this specification with reference to specific implementations and corresponding accompanying drawings of this specification. Clearly, the described implementations are merely some but not all of implementations of this specification. All other implementations obtained by a person of ordinary skill in the art based on the implementations of this specification without creative efforts shall fall within the protection scope of this application.

Currently, in a process of executing a service by using a blockchain technology, a privacy protection system can help a service participant to protect service privacy. Using a goods transportation service as an example, a goods sender sends a certain quantity of products to a goods receiver. For some reason, for example, the goods receiver urgently needs a batch of products for promotional activities to grab more market shares, but does not want a quantity of received goods to be known to competitors, so as not to arouse vigilance of the competitors. Therefore, neither the goods sender nor the goods receiver wants a specific quantity of sent products to be known to a third party. Therefore, when a to-be-executed service is processed by using a blockchain, not only natural features of real-time confirmation and non-tamperability of the blockchain can be used, but also a quantity of products can be encrypted to perform privacy protection.

However, in an existing homomorphic encryption privacy protection solution based on a zero-knowledge proof, there may be a case in which the goods receiver cannot decrypt a quantity of products obtained after homomorphic encryption.

Based on this, this specification provides a privacy protection system to partially resolve the existing problem.

The following describes in detail the technical solutions provided in the implementations of this specification with reference to the accompanying drawings.

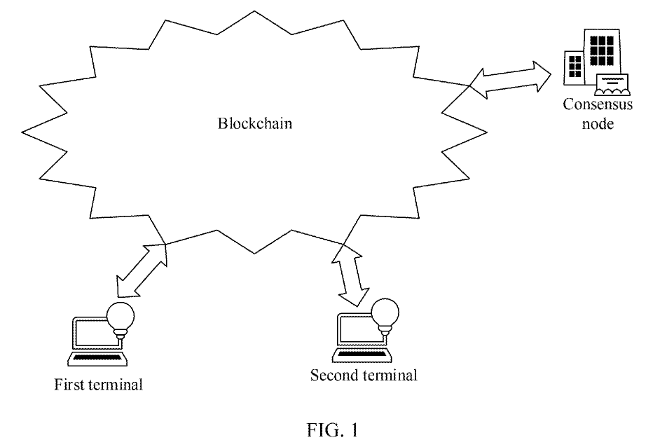

FIG. 1 is a schematic diagram of a structure of a privacy protection system according to this specification. The system is applied to a blockchain, and includes a first terminal, a second terminal, and a consensus node. Certainly, a specific type of service data on which the system performs privacy protection is not limited in this specification, and can be specifically set abased on an actual requirement. For convenience of description, subsequently, a goods transportation service is still used as an example to describe performing privacy protection on a quantity of products sent by a goods sender to a goods receiver. Therefore, the goods sender can be the first terminal, the goods receiver can be the second terminal, and a stakeholder of the goods sender and the goods receiver can be the consensus node.

As shown in FIG. 1, the first terminal, the second terminal, and the consensus node execute a to-be-executed service by using a blockchain.

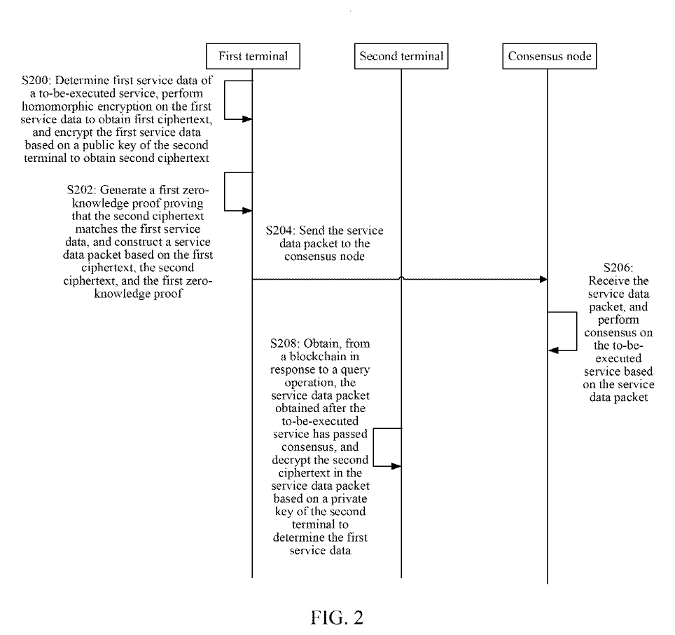

To facilitate understanding of a privacy protection process, based on the privacy protection system shown in FIG. 1, this specification provides an interaction flowchart of the privacy protection system, as shown in FIG. 2.

S200: The first terminal determines first service data of a to-be-executed service, performs homomorphic encryption on the first service data to obtain first ciphertext, where the first ciphertext is used to execute the to-be-executed service, and encrypts the first service data based on a public key of the second terminal to obtain second ciphertext.

In one or more implementations of this specification, the goods sender determines the first service data of the to-be-executed service, and if a certain quantity of products needs to be sent to the goods receiver, the quantity of products is the first service data. In a privacy protection scenario, for ease of calculation of an increase or a decrease in the quantity of products, the goods sender performs homomorphic encryption on the first service data to obtain the first ciphertext, where the first ciphertext is used to execute the to-be-executed service. For example, addition and subtraction based on homomorphic encryption can be performed on data (that is, the first ciphertext) obtained after homomorphic encryption. Then, asymmetric encryption is performed on the first service data based on a public key of the goods receiver to obtain the second ciphertext. In this case, the second ciphertext can be decrypted by the goods receiver by using a private key.

S202: The first terminal generates a first zero-knowledge proof proving that the second ciphertext matches the first service data, and constructs a service data packet based on the first ciphertext, the second ciphertext, and the first zero-knowledge proof.

In one or more implementations of this specification, the goods sender generates the first zero-knowledge proof proving that the second ciphertext matches the first service data, and constructs the service data packet based on the first ciphertext, the second ciphertext, and the first zero-knowledge proof.

It should be noted that, the first zero-knowledge proof proving that the second ciphertext matches the first service data ensures that the goods receiver can decrypt plaintext of the first service data based on the private key of the goods receiver. Even if homomorphic decryption is not performed on the first ciphertext, the plaintext of the first service data can be decrypted relying on the private key, to obtain data that is consistent with a result obtained after homomorphic decryption is performed on the first ciphertext.

S204: The first terminal sends the service data packet to the consensus node.

In one or more implementations of this specification, when sending the first service data to the goods receiver by using the blockchain, the goods sender initiates the to-be-executed service on the blockchain, and verifies an address of a blockchain account of the goods sender, an address of a blockchain account of the goods receiver, a signature of a private key of the goods sender for the to-be-executed service, etc. to determine legality of an identity of the goods sender and feasibility of the to-be-executed service. When the verification succeeds, the goods sender sends the service data packet to the blockchain, and broadcasts the service data packet to the consensus node. After receiving the service data packet, the consensus node on the blockchain performs consensus on the to-be-executed service.

S206: The consensus node receives the service data packet, and performs consensus on the to-be-executed service based on the service data packet.

In one or more implementations of this specification, the consensus node receives the service data packet, and determines that the signature of the goods sender for to-be-executed service, the first zero-knowledge proof, etc. are valid. Then, the consensus node puts the to-be-executed service that succeeds in the preliminary verification into a transaction pool, and waits for the to-be-executed service and the service data packet of the to-be-executed service to be packed into a block. Afterwards, a remaining consensus node can select the to-be-executed service from the transaction pool, constructs a new block, and then performs consensus on the new block by using a consensus mechanism. After the consensus succeeds, the consensus node declares the new block, and therefore, more consensus nodes verify the block. After the verification, if most consensus nodes agree that the block is valid, the block is broadcast to an entire blockchain network. After receiving the new block, another node in the blockchain network adds the new block to an end of a blockchain copy of the node. Once the block is added to the blockchain, a transaction in the block is considered confirmed. Generally, addition of more blocks to the blockchain makes transaction confirmation more secure and irreversible.

S208: The second terminal obtains, from the blockchain in response to a query operation, the service data packet obtained after the to-be-executed service has passed consensus, and decrypts the second ciphertext in the service data packet based on a private key of the second terminal to determine the first service data.

In one or more implementations of this specification, the goods receiver obtains, from the blockchain in response to a query operation, the service data packet obtained after the to-be-executed service has passed consensus, and performs asymmetric decryption on the second ciphertext in the service data packet based on the private key of the goods receiver to determine the first service data. The plaintext of the first service data can be obtained by decrypting the second ciphertext without first performing homomorphic decryption on the first ciphertext, to determine the first service data sent by the goods sender.

Afterwards, the goods receiver determines, based on the first service data, that execution of the to-be-executed service is completed; determines, based on the to-be-executed service, second service data required by the first terminal, that is, the goods sender, to execute a subsequent task of the to-be-executed service; and sends the second service data to the goods sender. In the goods transportation service, the goods receiver receives 100 products sent by the goods sender, and a result obtained by the goods receiver by decrypting the second ciphertext is also 100. In this case, the goods receiver can determine that execution of the service is completed, and can indicate, to the goods sending part, that the 100 products have been received, to ensure off-chain completion of the to-be-executed service, and enable the goods sender to know that the transportation task is completed. The goods sender can continue to use transportation force of the 100 products to execute a remaining transportation task.

With a feature such as non-tamperability of the blockchain, information about the to-be-executed service is stored on the blockchain. The blockchain is used to certify the to-be-executed service, to ensure that information about a service execution process of the to-be-executed service is stored on the blockchain, and it is easy to check and trace the service after the service is completed.

The privacy protection system shown in FIG. 1 is applied to a blockchain, and includes a first terminal, a second terminal, and a consensus node. The first terminal is configured to: determine first service data of a to-be-executed service, perform homomorphic encryption on the first service data to obtain first ciphertext, and encrypt the first service data based on a public key of the second terminal to obtain second ciphertext; generate a first zero-knowledge proof proving that the second ciphertext matches the first service data, and construct a service data packet based on the first ciphertext, the second ciphertext, and the first zero-knowledge proof; and send the service data packet to the consensus node. The consensus node is configured to: receive the service data packet, and perform consensus on the to-be-executed service based on the service data packet. The second terminal is configured to: obtain, from the blockchain in response to a query operation, the service data packet obtained after the to-be-executed service has passed consensus, and decrypt the second ciphertext in the service data packet to determine the first service data.

Homomorphic encryption is performed on the service data of the to-be-executed service, so that privacy protection can be performed on the service data of the to-be-executed service between the first terminal and the second terminal. The service data is encrypted by using the key of the second terminal, so that the second terminal can decrypt the service data of the to-be-executed service, thereby ensuring that the service is executable. The zero-knowledge proof is further used to ensure consistency between the second ciphertext and the first service data, so that the service data that is of the to-be-executed service and that can be decrypted by the second terminal is trusted. Even if the first ciphertext obtained after homomorphic encryption is not successfully decrypted, execution of the to-be-executed service is not affected.

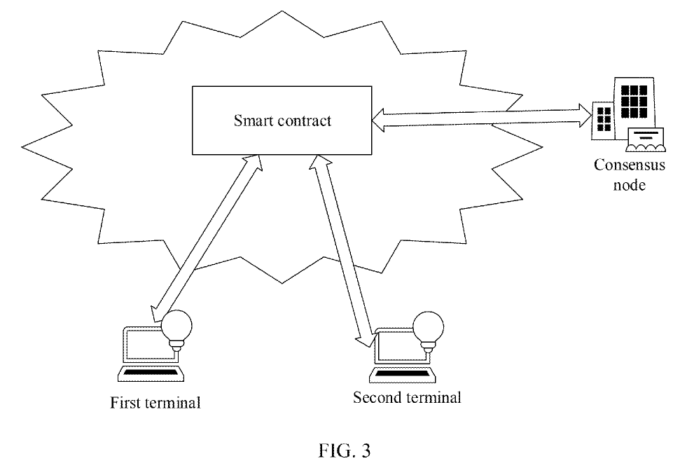

FIG. 3 is a schematic diagram of a structure of a privacy protection system including a smart contract according to this specification. The system is applied to a blockchain, and includes a first terminal, a second terminal, a consensus node, and the smart contract. Certainly, a specific type of service data on which the system performs privacy protection is not limited in this specification, and can be specifically set abased on an actual requirement. For convenience of description, subsequently, a goods transportation service is still used as an example to describe performing privacy protection on a quantity of products sent by a goods sender to a goods receiver. Therefore, the goods sender can be the first terminal, the goods receiver can be the second terminal, and a stakeholder of the goods sender and the goods receiver can be the consensus node.

As shown in FIG. 3, the first terminal, the second terminal, and the consensus node all can invoke the smart contract to execute a to-be-executed service.

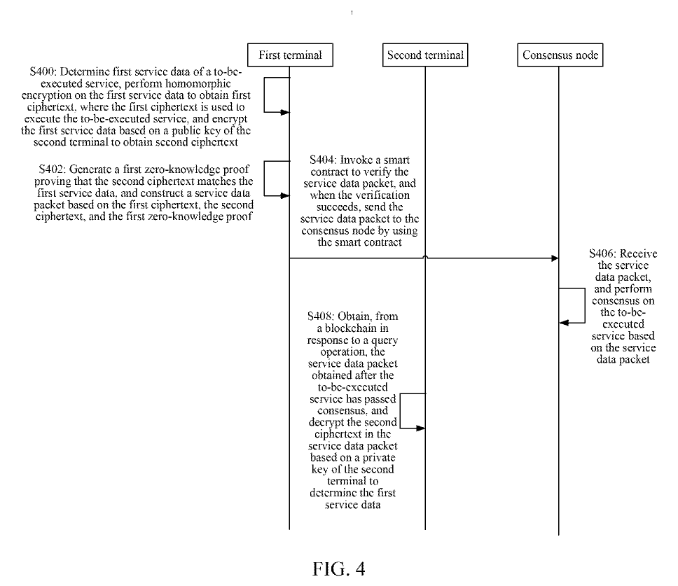

To facilitate understanding of a privacy protection process, based on the privacy protection system shown in FIG. 3, this specification provides an interaction flowchart of the privacy protection system including the smart contract, as shown in FIG. 4.

S400: The first terminal determines first service data of a to-be-executed service, performs homomorphic encryption on the first service data to obtain first ciphertext, where the first ciphertext is used to execute the to-be-executed service, and encrypts the first service data based on a public key of the second terminal to obtain second ciphertext.

In one or more implementations of this specification, the goods sender determines the first service data of the to-be-executed service, and if a certain quantity of products needs to be sent to the goods receiver, the quantity of products is the first service data. In a privacy protection scenario, for ease of calculation of an increase or a decrease in the quantity of products, the goods sender performs homomorphic encryption on the first service data to obtain the first ciphertext, where the first ciphertext is used to execute the to-be-executed service. For example, addition and subtraction based on homomorphic encryption can be performed on data (that is, the first ciphertext) obtained after homomorphic encryption. Then, asymmetric encryption is performed on the first service data based on a public key of the goods receiver to obtain the second ciphertext. In this case, the second ciphertext can be decrypted by the goods receiver by using a private key.

S402: The first terminal generates a first zero-knowledge proof proving that the second ciphertext matches the first service data, and constructs a service data packet based on the first ciphertext, the second ciphertext, and the first zero-knowledge proof.

In one or more implementations of this specification, the goods sender generates the first zero-knowledge proof proving that the second ciphertext matches the first service data, and constructs the service data packet based on the first ciphertext, the second ciphertext, and the first zero-knowledge proof.

It should be noted that, the first zero-knowledge proof proving that the second ciphertext matches the first service data ensures that the goods receiver can decrypt plaintext of the first service data based on the private key of the goods receiver. Even if homomorphic decryption is not performed on the first ciphertext, the plaintext of the first service data can be decrypted relying on the private key, to obtain data that is consistent with a result obtained after homomorphic decryption is performed on the first ciphertext.

S404: The first terminal invokes the smart contract to verify the service data packet, and when the verification succeeds, sends the service data packet to the consensus node by using the smart contract.

In one or more implementations of this specification, the goods sender invokes an interface of the smart contract through a request for invoking the smart contract, and verifies the service data packet of the to-be-executed service by using the smart contract. Certainly, when invoking the smart contract to verify the service data packet, the goods sender further verifies an address of a blockchain account of the goods sender, an address of a blockchain account of the goods receiver, a function and a parameter of the smart contract to be executed, a signature of a private key of the goods sender for the to-be-executed service, etc. to determine legality of an identity of the goods sender and feasibility of the to-be-executed service. When all of the verification performed by using the smart contract succeeds, the goods sender sends the service data packet to the blockchain by using the smart contract, and broadcasts the service data packet to the consensus node. After receiving the service data packet, the consensus node on the blockchain performs consensus on the to-be-executed service. It should be noted that, after the smart contract is deployed on the blockchain, code and functions of the smart contract cannot be modified by a single node or a terminal. Integrity and security of the smart contract are ensured by a non-tamperability feature of the blockchain, and a single node can be prevented from doing evil by using a consensus mechanism or other means.

If the verification performed by using the smart contract fails, the to-be-executed service cannot be confirmed on the blockchain, which indicates that the to-be-executed service is at risk and cannot continue to be executed.

S406: The consensus node receives the service data packet, and performs consensus on the to-be-executed service based on the service data packet.

In one or more implementations of this specification, the consensus node receives the service data packet, invokes the interface of the smart contract to verify the to-be-executed service by using the smart contract, and determines that the signature of the goods sender for the to-be-executed service, the first zero-knowledge proof, etc. are valid. Then, the consensus node puts the to-be-executed service that succeeds in the preliminary verification into a transaction pool, and waits for the to-be-executed service and the service data packet of the to-be-executed service to be packed into a block. Afterwards, a remaining consensus node can select the to-be-executed service from the transaction pool, constructs a new block, and then performs consensus on the new block by using a consensus mechanism. After the consensus succeeds, the consensus node declares the new block, and therefore, more consensus nodes verify the block. After the verification, if most consensus nodes agree that the block is valid, the block is broadcast to an entire blockchain network. After receiving the new block, another node in the blockchain network adds the new block to an end of a blockchain copy of the node. Once the block is added to the blockchain, a transaction in the block is considered confirmed. Generally, addition of more blocks to the blockchain makes transaction confirmation more secure and irreversible. Certainly, during block construction, related smart contract code is executed and a status change of the code is included in the new block.

S408: The second terminal obtains, from the blockchain in response to a query operation, the service data packet obtained after the to-be-executed service has passed consensus, and decrypts the second ciphertext in the service data packet based on a private key of the second terminal to determine the first service data.

In one or more implementations of this specification, the goods receiver obtains, from the blockchain in response to a query operation, the service data packet obtained after the to-be-executed service has passed consensus, and performs asymmetric decryption on the second ciphertext in the service data packet based on the private key of the goods receiver to determine the first service data. The plaintext of the first service data can be obtained by decrypting the second ciphertext without first performing homomorphic decryption on the first ciphertext, to determine the first service data sent by the goods sender.

Afterwards, the goods receiver determines, based on the first service data, that execution of the to-be-executed service is completed; determines, based on the to-be-executed service, second service data required by the first terminal, that is, the goods sender, to execute a subsequent task of the to-be-executed service; and sends the second service data to the goods sender. In the goods transportation service, the goods receiver receives 100 products sent by the goods sender, and a result obtained by the goods receiver by decrypting the second ciphertext is also 100. In this case, the goods receiver can determine that execution of the service is completed, and can indicate, to the goods sending part, that the 100 products have been received, to ensure off-chain completion of the to-be-executed service, and enable the goods sender to know that the transportation task is completed. The goods sender can continue to use transportation force of the 100 products to execute a remaining transportation task.

With a feature such as non-tamperability of the blockchain, information about the to-be-executed service is stored on the blockchain. The blockchain is used to certify the to-be-executed service, to ensure that information about a service execution process of the to-be-executed service is stored on the blockchain, and it is easy to check and trace the service after the service is completed.

The privacy protection system shown in FIG. 3 is applied to a blockchain, and includes a first terminal, a second terminal, and a consensus node. The first terminal is configured to: determine first service data of a to-be-executed service, perform homomorphic encryption on the first service data to obtain first ciphertext, and perform asymmetric encryption on the first service data based on a public key of the second terminal to obtain second ciphertext; generate a first zero-knowledge proof proving that the second ciphertext matches the first service data, and construct a service data packet based on the first ciphertext, the second ciphertext, and the first zero-knowledge proof; and invoke a smart contract to verify the service data packet, and when the verification succeeds, send the service data packet to the consensus node by using the smart contract. The consensus node is configured to: receive the service data packet, and perform consensus on the to-be-executed service based on the service data packet. The second terminal is configured to: obtain, from the blockchain in response to a query operation, the service data packet obtained after the to-be-executed service has passed consensus, and perform asymmetric decryption on the second ciphertext in the service data packet to determine the first service data.

Homomorphic encryption is performed on the service data of the to-be-executed service, so that privacy protection can be performed on the service data of the to-be-executed service between the first terminal and the second terminal. The service data is encrypted by using the key of the second terminal, so that the second terminal can decrypt the service data of the to-be-executed service, thereby ensuring that the service is executable. Further, the zero-knowledge proof is used to ensure that the service data that is of the to-be-executed service and that can be decrypted by the second terminal is trusted. In addition, the service data packet of the to-be-executed service is verified by using the smart contract, and the to-be-executed service continues to proceed on the blockchain only when the verification succeeds, thereby increasing supervisability of the to-be-executed service.

In addition, in one or more implementations of this specification, the first terminal is configured to: invoke the smart contract to verify the service data packet, and when the verification succeeds, send the service data packet to the consensus node by using the smart contract.

In one or more implementations of this specification, the first terminal can be a user terminal. In this case, when generating the first zero-knowledge proof proving that the second ciphertext matches the first service data, the user terminal can further generate a second zero-knowledge proof proving that the first service data supports the to-be-executed service and a third zero-knowledge proof proving that service data of the user terminal supports execution of the to-be-executed service; and then construct the service data packet based on the first ciphertext, the second ciphertext, the first zero-knowledge proof, the second zero-knowledge proof, and the third zero-knowledge proof. The user terminal invokes the smart contract to verify whether the first zero-knowledge proof, the second zero-knowledge proof, and the third zero-knowledge proof in the service data packet are valid. If all succeeds in the verification, the user terminal updates the service data of the user terminal and service data of the second terminal based on the first ciphertext by using the smart contract.

The second zero-knowledge proof proving that the first service data supports the to-be-executed service is equivalent to the following: A quantity of products sent by the first terminal serving as the goods sender is valid, and the quantity of goods is greater than zero, rather than an incorrect quantity value. The third zero-knowledge proof proving that the service data of the user terminal supports execution of the to-be-executed service is equivalent to the following: A quantity of products owned by the first terminal serving as the goods sender satisfies the to-be-executed service, and the quantity of products owned by the first terminal is greater than the first service data.

In one or more implementations of this specification, the first terminal is an issuing institution terminal. The issuing institution terminal represents a terminal with issuance rights.

The issuing institution terminal generates a second zero-knowledge proof proving that the first service data supports the to-be-executed service; constructs the service data packet based on the first ciphertext, the second ciphertext, the first zero-knowledge proof, and the second zero-knowledge proof; then invokes the smart contract to verify the first zero-knowledge proof and the second zero-knowledge proof in the service data packet; and if both succeeds in the verification, updates service data of the second terminal based on the first ciphertext by using the smart contract.

The second zero-knowledge proof proving that the first service data supports the to-be-executed service is equivalent to that a quantity of products sent by the issuing institution terminal serving as the goods sender is valid and the quantity of goods is greater than zero. In this case, the issuing institution terminal no longer needs to prove whether service data of the issuing institution terminal supports the to-be-executed service.

In one or more implementations of this specification, the privacy protection system further includes a supervisory node.

FIG. 5 is a schematic diagram of a structure of a privacy protection system including a regulatory authority according to this specification. As shown in FIG. 5, the system includes a first terminal, a second terminal, a consensus node, and a supervisory node. The supervisory node can supervise the to-be-executed service by using the smart contract, and trace the first service data.

The first terminal performs asymmetric encryption on the first service data based on a public key of the supervisory node to obtain third ciphertext; then generates a fourth zero-knowledge proof proving that the third ciphertext matches the first service data; constructs the service data packet based on the first ciphertext, the second ciphertext, the third ciphertext, the first zero-knowledge proof, and the fourth zero-knowledge proof; afterwards, invokes the smart contract to verify the first zero-knowledge proof and the fourth zero-knowledge proof in the service data packet; and if both succeeds in the verification, sends the service data packet the consensus node by using the smart contract.

It should be noted that in this case, the first terminal can alternatively directly generate a zero-knowledge proof proving that both the second ciphertext and the third ciphertext match the first service data, which is equivalent to the following: The zero-knowledge proof can prove that the second ciphertext matches the first service data, and can also prove that the third ciphertext matches the first service data.

The supervisory node receives the service data packet, and performs asymmetric decryption on the third ciphertext in the service data packet based on a private key of the monitoring node to determine the first service data; and determines a risk control policy for the to-be-executed service based on the first service data. Therefore, the supervisory node not only can decrypt plaintext of the first service data by using the private key, but also can determine, by using the fourth zero-knowledge proof, that the plaintext decrypted by using the private key is trusted.

It should be noted that in this case, when the first terminal is a user terminal, the service data packet constructed by the first terminal can include a second zero-knowledge proof proving that the first service data supports the to-be-executed service and a third zero-knowledge proof proving that service data of the user terminal supports execution of the to-be-executed service. When the first terminal is an issuing institution terminal, the service data packet can include the second zero-knowledge proof proving that the first service data supports the to-be-executed service.

In one or more implementations of this specification, the first terminal is an issuing institution terminal.

The second terminal is configured to send, in response to a conversion operation, a conversion request including the first service data to the issuing institution terminal. In this case, the second terminal hopes to convert the first service data into a resource on a non-blockchain.

The issuing institution terminal is configured to: determine the first service data based on the received conversion request; and monitor a consensus result of the consensus node, and after it is determined that the consensus result of the consensus node is that the consensus succeeds, update service data of an issuing institution account of the second terminal based on the first service data, and push updated service data of the issuing institution account of the second terminal to the second terminal. In this case, the updating service data of an issuing institution account of the second terminal based on the first service data means exchanging the first service data for a resource on a non-blockchain, and adding the resource to a non-blockchain account of the second terminal, that is, an account of the issuing institution terminal. Certainly, if the consensus result is that the consensus fails, the issuing institution terminal continues to execute the conversion request again until the consensus result is that the consensus succeeds. If a quantity of times that the consensus result is that the consensus fails reaches a predetermined quantity of times, the issuing institution terminal needs to detect an execution process of the to-be-executed service.

It should be noted that the privacy protection system further includes a supervisory node.

The issuing institution terminal performs asymmetric encryption on the first service data based on a public key of the supervisory node to obtain fourth ciphertext; generates a fifth zero-knowledge proof proving that the fourth ciphertext matches the first service data; and constructs the service data packet based on the first ciphertext, the second ciphertext, the fourth ciphertext, the first zero-knowledge proof, and the fifth zero-knowledge proof.

The supervisory node receives the service data packet, and performs asymmetric decryption on the fourth ciphertext in the service data packet based on a private key of the supervisory node to determine the first service data; and determines a risk control policy for the to-be-executed service based on the first service data.

In one or more implementations of this specification, when the first terminal is a user terminal, the user terminal is further configured to: generate a second zero-knowledge proof proving that the first service data supports the to-be-executed service and a third zero-knowledge proof proving that service data of the user terminal supports execution of the to-be-executed service; and construct the service data packet based on the first ciphertext, the second ciphertext, the first zero-knowledge proof, the second zero-knowledge proof, and the third zero-knowledge proof. Subsequently, the service data packet is not verified by using the smart contract, and can be sent by the first terminal to the consensus node, and the consensus node performs verification and consensus.

In one or more implementations of this specification, when the first terminal is an issuing institution terminal, the issuing institution terminal is configured to: generate a second zero-knowledge proof proving that the first service data supports the to-be-executed service; and construct the service data packet based on the first ciphertext, the second ciphertext, the first zero-knowledge proof, and the second zero-knowledge proof. Subsequently, the service data packet is not verified by using the smart contract, and can be sent by the first terminal to the consensus node, and the consensus node performs verification and consensus.

In one or more implementations of this specification, the privacy protection system can further be a privacy protection system in currency payment. When two users perform a transaction, such as shopping, after a transaction amount is determined through negotiation on a shopping platform, payment is performed by using the privacy protection system, to ensure that sensitive information such as the transaction amount is not disclosed. For ease of description, subsequently, such a case is described by using the privacy protection system in currency payment an example. In this case, a payer in two transaction parties can serve the first terminal, and a payee in the two transaction parties can serve as a second terminal. The to-be-executed service can be a to-be-traded service, and the first service data can be a first currency amount.

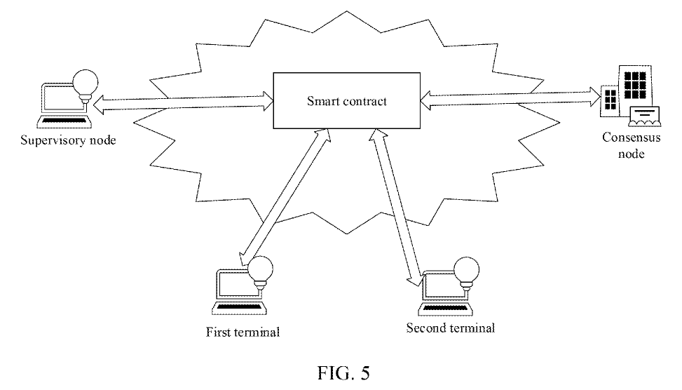

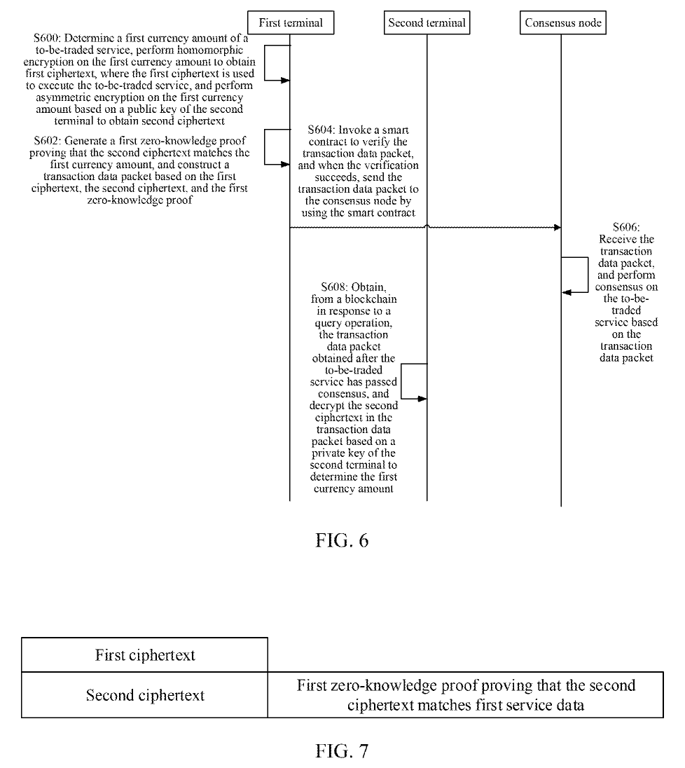

FIG. 6 is an interaction flowchart of a privacy protection system in currency payment according to this specification, as shown in FIG. 6.

S600: The first terminal determines a first currency amount of a to-be-traded service, performs homomorphic encryption on the first currency amount to obtain first ciphertext, where the first ciphertext is used to execute the to-be-traded service, and performs asymmetric encryption on the first currency amount based on a public key of the second terminal to obtain second ciphertext.

In one or more implementations of this specification, the first terminal determines the first currency amount of the to-be-traded service, and if a certain amount of currency needs to be paid to the second terminal, the amount of the currency is the first currency amount. In a privacy protection scenario, for ease of calculation of an increase or a decrease in the amount of the currency, the first terminal performs homomorphic encryption on the first currency amount to obtain the first ciphertext, where the first ciphertext is used to execute the to-be-traded service. For example, addition and subtraction based on homomorphic encryption can be performed on data (the first ciphertext) obtained after homomorphic encryption. Then, asymmetric encryption is performed on the first currency amount based on the public key of the second terminal to obtain the second ciphertext. In this case, the second ciphertext can be decrypted by the second terminal by using a private key.

S602: The first terminal generates a first zero-knowledge proof proving that the second ciphertext matches the first currency amount, and constructs a transaction data packet based on the first ciphertext, the second ciphertext, and the first zero-knowledge proof.

In one or more implementations of this specification, the first terminal generates the first zero-knowledge proof proving that the second ciphertext matches the first currency amount, and constructs the transaction data packet based on the first ciphertext, the second ciphertext, and the first zero-knowledge proof.

It should be noted that, the first zero-knowledge proof proving that the second ciphertext matches the first currency amount ensures that the second terminal can decrypt plaintext of the first currency amount based on the private key of the second terminal. Even if homomorphic decryption is not performed on the first ciphertext, the plaintext of the first currency amount can be decrypted relying on the private key, to obtain data that is consistent with a result obtained after homomorphic decryption is performed on the first ciphertext.

FIG. 7 is a schematic diagram of a transaction data packet according to this specification. As shown in FIG. 7, the transaction data packet includes the first ciphertext, the second ciphertext, and the first zero-knowledge proof.

S604: The first terminal invokes a smart contract to verify the transaction data packet, and when the verification succeeds, sends the transaction data packet to the consensus node by using the smart contract.

In one or more implementations of this specification, the first terminal invokes an interface of the smart contract through a request for invoking the smart contract, and verifies the transaction data packet of the to-be-traded service by using the smart contract. Certainly, when invoking the smart contract to verify the transaction data packet, the first terminal further verifies an address of a blockchain account of the first terminal, an address of a blockchain account of the second terminal, a function and a parameter of the smart contract to be executed, a signature of a private key of the first terminal for the to-be-traded service, etc. to determine legality of an identity of the first terminal and feasibility of the to-be-traded service. When all of the verification performed by using the smart contract succeeds, the first terminal sends the transaction data packet to the blockchain by using the smart contract, and broadcasts the transaction data packet to the consensus node. After receiving the transaction data packet, the consensus node on the blockchain performs consensus on the to-be-traded service. It should be noted that, after the smart contract is deployed on the blockchain, code and functions of the smart contract cannot be modified by a single node or a terminal. Integrity and security of the smart contract are ensured by a non-tamperability feature of the blockchain, and a single node can be prevented from doing evil by using a consensus mechanism or other means.

If the verification performed by using the smart contract fails, the to-be-traded service cannot be confirmed on the blockchain, which indicates that the to-be-traded service is at risk and cannot continue to be executed.

S606: The consensus node receives the transaction data packet, and performs consensus on the to-be-traded service based on the transaction data packet.

In one or more implementations of this specification, the consensus node receives the transaction data packet, invokes the interface of the smart contract to verify the to-be-traded service by using the smart contract, and determines that the signature of the first terminal for the to-be-traded service, the first zero-knowledge proof, etc. are valid. Then, the consensus node puts the to-be-traded service that succeeds in the preliminary verification into a transaction pool, and waits for the to-be-traded service and the transaction data packet of the to-be-traded service to be packed into a block. Afterwards, a remaining consensus node can select the to-be-traded service from the transaction pool, constructs a new block, and then performs consensus on the new block by using a consensus mechanism. After the consensus succeeds, the consensus node declares the new block, and therefore, more consensus nodes verify the block. After the verification, if most consensus nodes agree that the block is valid, the block is broadcast to an entire blockchain network. After receiving the new block, another node in the blockchain network adds the new block to an end of a blockchain copy of the node. Once the block is added to the blockchain, a transaction in the block is considered confirmed. Generally, addition of more blocks to the blockchain makes transaction confirmation more secure and irreversible. Certainly, during block construction, related smart contract code is executed and a status change of the code is included in the new block.

S608: The second terminal obtains, from the blockchain in response to a query operation, the transaction data packet obtained after the to-be-traded service has passed consensus, and decrypts the second ciphertext in the transaction data packet based on a private key of the second terminal to determine the first currency amount.

In one or more implementations of this specification, the second terminal obtains, from the blockchain in response to the query operation, the transaction data packet obtained after the to-be-traded service has passed consensus, and performs asymmetric decryption on the second ciphertext in the transaction data packet based on the private key of the second terminal to determine the first currency amount. The plaintext of the first currency amount can be obtained by decrypting the second ciphertext without first performing homomorphic decryption on the first ciphertext, to determine the first currency amount sent by the first terminal.

Afterwards, the second terminal determines, based on the first currency amount, that execution of the to-be-traded service is completed; and determines, based on the to-be-traded service, second service data required by the first terminal to execute a subsequent task of the to-be-traded service, and sends the second service data to the first terminal. In a currency payment service, when the second terminal receives the first currency amount sent by the first terminal, and a result obtained by the second terminal by decrypting the second ciphertext is correct, the second terminal can determine that execution of the transaction payment is completed, and can indicate, to the first terminal, that the first currency amount has been received, and send a service or a product, that is, the second service data, that is equivalent to the first currency amount to the first terminal, to ensure off-chain completion of the to-be-traded service.

Homomorphic encryption is performed on the currency amount of the to-be-traded service, so that privacy protection can be performed on the currency amount of the to-be-traded service between the first terminal and the second terminal. The currency amount is encrypted by using the key of the second terminal, so that the second terminal can decrypt the currency amount of the to-be-traded service, thereby ensuring that the transaction is executable. Further, the zero-knowledge proof is used to ensure that the currency amount that is of the to-be-traded service and that can be decrypted by the second terminal is trusted. In addition, the transaction data packet of the to-be-traded service is verified by using the smart contract, and the to-be-traded service continues to proceed on the blockchain only when the verification succeeds, thereby increasing supervisability of the to-be-traded service.

In addition, in one or more implementations of this specification, when the first terminal is a user terminal, the user terminal can further generate, when generating the first zero-knowledge proof proving that the second ciphertext matches the first currency amount, a second zero-knowledge proof proving that the first currency amount supports the to-be-traded service and a third zero-knowledge proof proving that a currency amount of the user terminal supports execution of the to-be-traded service; and then construct the transaction data packet based on the first ciphertext, the second ciphertext, the first zero-knowledge proof, the second zero-knowledge proof, and the third zero-knowledge proof. The user terminal invokes the smart contract to verify whether the first zero-knowledge proof, the second zero-knowledge proof, and the third zero-knowledge proof in the transaction data packet are valid. If all succeeds in the verification, the user terminal updates the currency amount of the user terminal and a currency amount of the second terminal based on the first ciphertext by using the smart contract.

The second zero-knowledge proof proving that the first currency amount supports the to-be-traded service is equivalent to the following: A currency amount sent by the first terminal serving as a payer is valid, and the currency amount is greater than zero, rather than an incorrect currency amount value such as a negative number. The third zero-knowledge proof proving that the currency amount of the user terminal supports execution of the to-be-traded service is equivalent to the following: A currency amount owned by the first terminal serving as a payer satisfies the to-be-traded service, and the currency amount owned by the first terminal is greater than the first currency amount, which indicates that the balance of the first terminal is sufficient.

FIG. 8 is a schematic diagram of a transaction data packet of a user terminal according to this specification. As shown in FIG. 8, the transaction data packet constructed by the user terminal includes the first ciphertext, the second ciphertext, the first zero-knowledge proof, the second zero-knowledge proof, and the third zero-knowledge proof.

In one or more implementations of this specification, the first terminal can alternatively be an issuing institution terminal. The issuing institution terminal represents a terminal with issuance rights, and is usually a bank terminal. In this specification, the smart contract is compiled by the issuing institution terminal.

The issuing institution terminal generates a second zero-knowledge proof proving that the first currency amount supports the to-be-traded service; constructs the transaction data packet based on the first ciphertext, the second ciphertext, the first zero-knowledge proof, and the second zero-knowledge proof; then invokes the smart contract to verify the first zero-knowledge proof and the second zero-knowledge proof in the transaction data packet; and if both succeeds in the verification, updates a currency amount of the second terminal based on the first ciphertext by using the smart contract.

The second zero-knowledge proof proving that the first currency amount supports the to-be-traded service is equivalent to the following: A currency amount sent by the issuing institution terminal serving as a currency issuing party is valid, and the currency amount is greater than zero. In this case, the issuing institution terminal no longer needs to prove whether a currency amount of the issuing institution terminal supports the to-be-traded service.

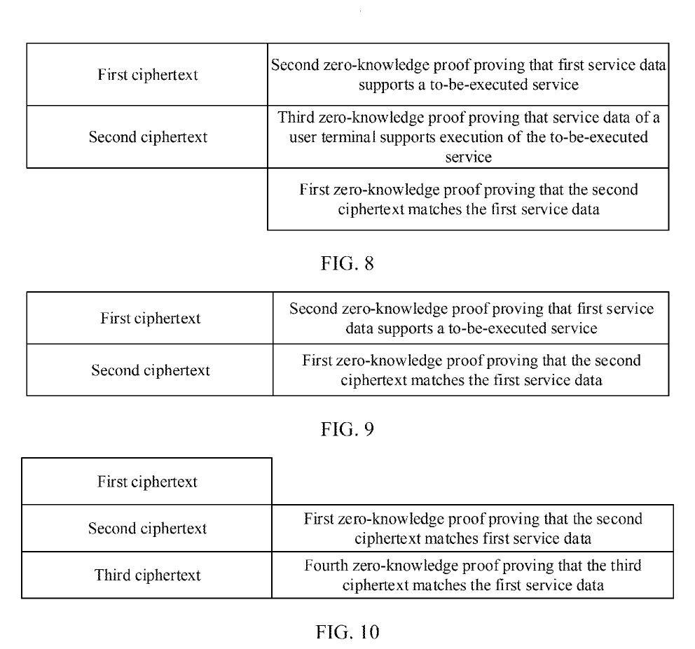

FIG. 9 is a schematic diagram of a transaction data packet of an issuing institution terminal according to this specification. As shown in FIG. 9, the transaction data packet constructed by the issuing institution terminal includes the first ciphertext, the second ciphertext, the first zero-knowledge proof, and the second zero-knowledge proof.

In one or more implementations of this specification, the privacy protection system further includes a supervisory node. In this specification, the supervisory node can be the issuing institution terminal, or can be an official institution in a region in which the first terminal and the second terminal are located. In this specification, a quantity of supervisory nodes is not fixed, and there can be one or more supervisory nodes. This is not limited.

The first terminal performs asymmetric encryption on the first currency amount based on a public key of the supervisory node to obtain third ciphertext; then generates a fourth zero-knowledge proof proving that the third ciphertext matches the first currency amount; constructs the transaction data packet based on the first ciphertext, the second ciphertext, the third ciphertext, the first zero-knowledge proof, and the fourth zero-knowledge proof; afterwards, invokes the smart contract to verify the first zero-knowledge proof and the fourth zero-knowledge proof in the transaction data packet; and if both succeeds in the verification, sends the transaction data packet to the consensus node by using the smart contract.

It should be noted that in this case, the first terminal can alternatively directly generate a zero-knowledge proof proving that both the second ciphertext and the third ciphertext match the first currency amount, which is equivalent to the following: The zero-knowledge proof can prove that the second ciphertext matches the first currency amount, and can also prove that the third ciphertext matches the first currency amount.

The supervisory node receives the transaction data packet, and performs asymmetric decryption on the third ciphertext in the transaction data packet to determine the first currency amount; and determines a risk control policy for the to-be-traded service based on the first currency amount. Therefore, the supervisory node not only can decrypt the plaintext of the first currency amount by using the private key, but also can determine, by using the fourth zero-knowledge proof, that the plaintext decrypted by using the private key is trusted.

FIG. 10 is a schematic diagram of a transaction data packet of a supervisory node according to this specification. As shown in FIG. 10, the transaction data packet includes the first ciphertext, the second ciphertext, the third ciphertext, the first zero-knowledge proof, and the fourth zero-knowledge proof.

It should be noted that in this case, when the first terminal is a user terminal, the transaction data packet constructed by the first terminal can include a second zero-knowledge proof proving that the first currency amount supports the to-be-traded service and a third zero-knowledge proof proving that a currency amount of the user terminal supports execution of the to-be-traded service. When the first terminal is an issuing institution terminal, the transaction data packet can include the second zero-knowledge proof proving that the first currency amount supports the to-be-traded service.

In one or more implementations of this specification, the first terminal is an issuing institution terminal.

The second terminal is configured to send, in response to a conversion operation, a conversion request including the first currency amount to the issuing institution terminal, to indicate that the second terminal needs to convert the first currency amount on the blockchain into an off-chain fund.

The issuing institution terminal is configured to: determine the first currency amount based on the received conversion request; and monitor a consensus result of the consensus node, and after it is determined that the consensus result of the consensus node is that the consensus succeeds, update a currency amount of an issuing institution account of the second terminal based on first currency amount, and push updated currency amount of the issuing institution account of the second terminal to the second terminal. Certainly, the issuing institution terminal adds, to the issuing institution account of the second terminal, a currency amount having a currency value the same as that of the first currency amount based on a conversion ratio between the first currency amount and the currency amount of the issuing institution account.

In this case, the second terminal receives the currency amount sent by the issuing institution terminal, which is equivalent to that the second terminal converts the first currency amount from the blockchain to the second terminal at the issuing institution terminal, and the second terminal obtains the currency amount that cannot be circulated on the blockchain, which is equivalent to converting digitized currency that can be circulated on the blockchain into real currency.

It should be noted that the privacy protection system further includes a supervisory node.

The issuing institution terminal performs asymmetric encryption on the first currency amount based on a public key of the supervisory node to obtain fourth ciphertext; generates a fifth zero-knowledge proof proving that the fourth ciphertext matches the first currency amount; and constructs the transaction data packet based on the first ciphertext, the second ciphertext, the fourth ciphertext, the first zero-knowledge proof, and the fifth zero-knowledge proof.

The supervisory node receives the transaction data packet, and performs asymmetric decryption on the fourth ciphertext in the transaction data packet to determine the first currency amount; and determines a risk control policy for the to-be-traded service based on the first currency amount.

In one or more implementations of this specification, when the first terminal is a user terminal, the user terminal is further configured to: generate a second zero-knowledge proof proving that the first currency amount supports the to-be-traded service and a third zero-knowledge proof proving that a currency amount of the user terminal supports execution of the to-be-traded service; and construct the transaction data packet based on the first ciphertext, the second ciphertext, the first zero-knowledge proof, the second zero-knowledge proof, and the third zero-knowledge proof. Subsequently, the transaction data packet is not verified by using the smart contract, and can be sent by the first terminal to the consensus node, and the consensus node performs verification and consensus.

In one or more implementations of this specification, when the first terminal is an issuing institution terminal, the issuing institution terminal is configured to: generate a second zero-knowledge proof proving that the first currency amount supports the to-be-traded service; and construct the transaction data packet based on the first ciphertext, the second ciphertext, the first zero-knowledge proof, and the second zero-knowledge proof. Subsequently, the transaction data packet is not verified by using the smart contract, and can be sent by the first terminal to the consensus node, and the consensus node performs verification and consensus.

In this specification, an application scenario is not limited to only a blockchain or an independent platform or system similar to the blockchain, and serving as a third party, the independent platform or system can store and maintain service data of a service participant.

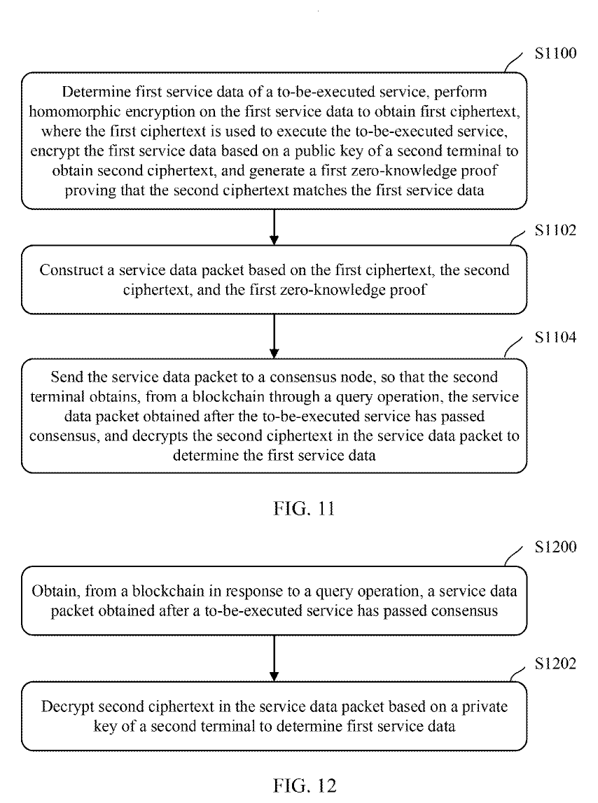

FIG. 11 is a schematic flowchart of a privacy protection method applied to a first terminal in a privacy protection system according to this specification. The privacy protection system is applied to a blockchain, and the privacy protection system includes the first terminal, a second terminal, and a consensus node. The method includes the following steps:

S1100: Determine first service data of a to-be-executed service, perform homomorphic encryption on the first service data to obtain first ciphertext, where the first ciphertext is used to execute the to-be-executed service, encrypt the first service data based on a public key of the second terminal to obtain second ciphertext, and generate a first zero-knowledge proof proving that the second ciphertext matches the first service data.

In one or more implementations of this specification, the first terminal determines the first service data of the to-be-executed service, performs homomorphic encryption on the first service data to obtain the first ciphertext, where the first ciphertext is used to execute the to-be-executed service, encrypts the first service data based on the public key of the second terminal to obtain the second ciphertext, and generates the first zero-knowledge proof proving that the second ciphertext matches the first service data.

S1102: Construct a service data packet based on the first ciphertext, the second ciphertext, and the first zero-knowledge proof.

In one or more implementations of this specification, the first terminal constructs the service data packet based on the first ciphertext, the second ciphertext, and the first zero-knowledge proof.

S1104: Send the service data packet to the consensus node, so that the second terminal obtains, from the blockchain through a query operation, the service data packet obtained after the to-be-executed service has passed consensus, and decrypts the second ciphertext in the service data packet to determine the first service data.

In one or more implementations of this specification, the first terminal sends the service data packet to the consensus node, so that the second terminal obtains, from the blockchain through the query operation, the service data packet obtained after the to-be-executed service has passed consensus, and performs asymmetric decryption on the second ciphertext in the service data packet to determine the first service data.

For specific details of steps S1100 to S1104 in the above-mentioned method, references can be made to the descriptions of the above-mentioned system. Details are not described herein again.

Based on FIG. 11, this specification provides a privacy protection method applied to a first terminal in a privacy protection system. The privacy protection system is applied to a blockchain, and the privacy protection system includes the first terminal, a second terminal, and a consensus node. The method includes: determining first service data of a to-be-executed service, performing homomorphic encryption on the first service data to obtain first ciphertext, performing asymmetric encryption on the first service data based on a public key of the second terminal to obtain second ciphertext, and generating a first zero-knowledge proof proving that the second ciphertext matches the first service data; constructing a service data packet based on the first ciphertext, the second ciphertext, and the first zero-knowledge proof; and sending the service data packet to the consensus node, so that the second terminal obtains, from the blockchain through a query operation, the service data packet obtained after the to-be-executed service has passed consensus, and performs asymmetric decryption on the second ciphertext in the service data packet to determine the first service data.

Homomorphic encryption is performed on the service data of the to-be-executed service, so that privacy protection can be performed on the service data of the to-be-executed service between the first terminal and the second terminal. The service data is encrypted by using the key of the second terminal, so that the second terminal can decrypt the service data of the to-be-executed service, thereby ensuring that the service is executable. Further, the zero-knowledge proof is used to ensure that the service data that is of the to-be-executed service and that can be decrypted by the second terminal is trusted.

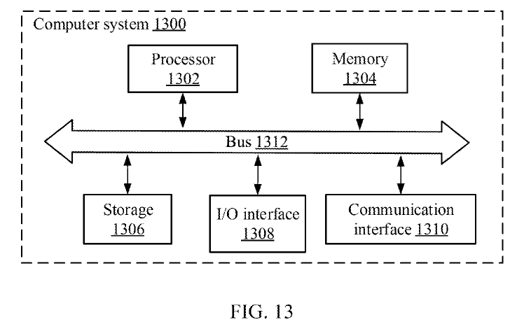

FIG. 12 is a schematic flowchart of a privacy protection method applied to a second terminal in a privacy protection system according to this specification. The privacy protection system is applied to a blockchain, and the privacy protection system includes a first terminal, the second terminal, and a consensus node. The method includes the following steps:

S1200: Obtain, from the blockchain in response to a query operation, a service data packet obtained after a to-be-executed service has passed consensus.

In one or more implementations of this specification, the second terminal obtains, from the blockchain in response to the query operation, the service data packet obtained after the to-be-executed service has passed consensus.

S1202: Decrypt second ciphertext in the service data packet based on a private key of the second terminal to determine first service data.

In one or more implementations of this specification, the second terminal performs asymmetric decryption on the second ciphertext in the service data packet based on the private key to determine the first service data.

For specific details of steps S1200 and S1202 in the above-mentioned method, references can be made to the descriptions of the above-mentioned system. Details are not described herein again.

The privacy protection method shown in FIG. 12 is applied to a second terminal in a privacy protection system. The privacy protection system is applied to a blockchain, and the privacy protection system includes a first terminal, the second terminal, and a consensus node. The method includes: obtaining, from the blockchain in response to a query operation, a service data packet obtained after a to-be-executed service has passed consensus; and performing asymmetric decryption on second ciphertext in the service data packet to determine first service data.

Homomorphic encryption is performed on the service data of the to-be-executed service, so that privacy protection can be performed on the service data of the to-be-executed service between the first terminal and the second terminal. The service data is encrypted by using the key of the second terminal, so that the second terminal can decrypt the service data of the to-be-executed service, thereby ensuring that the service is executable. Further, the zero-knowledge proof is used to ensure that the service data that is of the to-be-executed service and that can be decrypted by the second terminal is trusted.

The specification also provides a computer-readable non-transitory storage medium, where the storage medium stores a computer program, which, when executed by a processor, can be used to perform one or more steps of one or more methods described or illustrated herein or provides functionality described or illustrated herein. Herein, the computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

The specification also provides a computer system. FIG. 13 illustrates an example computer system 1300. In particular implementations, one or more computer systems 1300 perform one or more steps of one or more methods described or illustrated herein. In particular implementations, one or more computer systems 1300 provide functionality described or illustrated herein. In particular implementations, software running on one or more computer systems 1300 performs one or more steps of one or more methods described or illustrated herein or provides functionality described or illustrated herein. Particular implementations include one or more portions of one or more computer systems 1300. Herein, reference to a computer system may encompass a computing device, and vice versa, where appropriate. Moreover, reference to a computer system may encompass one or more computer systems, where appropriate.

This disclosure contemplates any suitable number of computer systems 1300. This disclosure contemplates computer system 1300 taking any suitable physical form. As example and not by way of limitation, computer system 1300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1300 may include one or more computer systems 1300; be unitary or distributed; span multiple locations; span multiple machines; span multiple data centers; or reside in a cloud, which may include one or more cloud components in one or more networks. Where appropriate, one or more computer systems 1300 may perform without substantial spatial or temporal limitation one or more steps of one or more methods described or illustrated herein. As an example and not by way of limitation, one or more computer systems 1300 may perform in real time or in batch mode one or more steps of one or more methods described or illustrated herein. One or more computer systems 1300 may perform at different times or at different locations one or more steps of one or more methods described or illustrated herein, where appropriate.

In particular implementations, computer system 1300 includes a processor 1302, memory 1304, storage 1306, an input/output (I/O) interface 1308, a communication interface 1310, and a bus 1312. Although this disclosure describes and illustrates a particular computer system having a particular number of particular components in a particular arrangement, this disclosure contemplates any suitable computer system having any suitable number of any suitable components in any suitable arrangement.

In particular implementations, processor 1302 includes hardware for executing instructions, such as those making up a computer program. As an example and not by way of limitation, to execute instructions, processor 1302 may retrieve (or fetch) the instructions from an internal register, an internal cache, memory 1304, or storage 1306; decode and execute them; and then write one or more results to an internal register, an internal cache, memory 1304, or storage 1306. In particular implementations, processor 1302 may include one or more internal caches for data, instructions, or addresses. This disclosure contemplates processor 1302 including any suitable number of any suitable internal caches, where appropriate. As an example and not by way of limitation, processor 1302 may include one or more instruction caches, one or more data caches, and one or more translation lookaside buffers (TLB s). Instructions in the instruction caches may be copies of instructions in memory 1304 or storage 1306, and the instruction caches may speed up retrieval of those instructions by processor 1302. Data in the data caches may be copies of data of 130 in memory 1304 or storage 1306 for instructions executing at processor 1302 to operate on; the results of previous instructions executed at processor 1302 for access by subsequent instructions executing at processor 1302 or for writing to memory 1304 or storage 1306; or other suitable data. The data caches may speed up read or write operations by processor 1302. The TLBs may speed up virtual-address translation for processor 1302. In particular implementations, processor 1302 may include one or more internal registers for data, instructions, or addresses. This disclosure contemplates processor 1302 including any suitable number of any suitable internal registers, where appropriate. Where appropriate, processor 1302 may include one or more arithmetic logic units (ALUs); be a multi-core processor; or include one or more processors 1302. Although this disclosure describes and illustrates a particular processor, this disclosure contemplates any suitable processor.

In particular implementations, memory 1304 includes main memory for storing instructions for processor 1302 to execute or data for processor 1302 to operate on. As an example and not by way of limitation, computer system 1300 may load instructions from storage 1306 or another source (such as, for example, another computer system 1300) to memory 1304. Processor 1302 may then load the instructions from memory 1304 to an internal register or internal cache. To execute the instructions, processor 1302 may retrieve the instructions from the internal register or internal cache and decode them. During or after execution of the instructions, processor 1302 may write one or more results (which may be intermediate or final results) to the internal register or internal cache. Processor 1302 may then write one or more of those results to memory 1304. In particular implementations, processor 1302 executes only instructions in one or more internal registers or internal caches or in memory 1304 (as opposed to storage 1306 or elsewhere) and operates only on data in one or more internal registers or internal caches or in memory 1304 (as opposed to storage 1306 or elsewhere). One or more memory buses (which may each include an address bus and a data bus) may couple processor 1302 to memory 1304. Bus 1312 may include one or more memory buses, as described below. In particular implementations, one or more memory management units (MMUs) reside between processor 1302 and memory 1304 and facilitate accesses to memory 1304 requested by processor 1302. In particular implementations, memory 1304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1304 may include one or more memories 1304, where appropriate. Although this disclosure describes and illustrates particular memory, this disclosure contemplates any suitable memory.

In particular implementations, storage 1306 includes mass storage for data or instructions. As an example and not by way of limitation, storage 1306 may include a hard disk drive (HDD), a floppy disk drive, flash memory, an optical disc, a magneto-optical disc, magnetic tape, or a Universal Serial Bus (USB) drive or a combination of two or more of these. Storage 1306 may include removable or non-removable (or fixed) media, where appropriate. Storage 1306 may be internal or external to computer system 1300, where appropriate. In particular implementations, storage 1306 is non-volatile, solid-state memory. In particular implementations, storage 1306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1306 taking any suitable physical form. Storage 1306 may include one or more storage control units facilitating communication between processor 1302 and storage 1306, where appropriate. Where appropriate, storage 1306 may include one or more storages 1306. Although this disclosure describes and illustrates particular storage, this disclosure contemplates any suitable storage.

In particular implementations, I/O interface 1308 includes hardware, software, or both, providing one or more interfaces for communication between computer system 1300 and one or more I/O devices. Computer system 1300 may include one or more of these I/O devices, where appropriate. One or more of these I/O devices may enable communication between a person and computer system 1300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1308 for them. Where appropriate, I/O interface 1308 may include one or more device or software drivers enabling processor 1302 to drive one or more of these I/O devices. I/O interface 1308 may include one or more I/O interfaces 1308, where appropriate. Although this disclosure describes and illustrates a particular I/O interface, this disclosure contemplates any suitable I/O interface.

In particular implementations, communication interface 1310 includes hardware, software, or both providing one or more interfaces for communication (such as, for example, packet-based communication) between computer system 1300 and one or more other computer systems 1300 or one or more networks. As an example and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1310 for it. As an example and not by way of limitation, computer system 1300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1300 may include any suitable communication interface 1310 for any of these networks, where appropriate. Communication interface 1310 may include one or more communication interfaces 1310, where appropriate. Although this disclosure describes and illustrates a particular communication interface, this disclosure contemplates any suitable communication interface.

In particular implementations, bus 1312 includes hardware, software, or both coupling components of computer system 1300 to each other. As an example and not by way of limitation, bus 1312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1312 may include one or more buses 1312, where appropriate. Although this disclosure describes and illustrates a particular bus, this disclosure contemplates any suitable bus or interconnect.

The above-mentioned descriptions are merely implementations of this specification, and are not intended to limit this specification. A person skilled in the art can make various modifications and variations to this specification. Any modification, equivalent replacement, improvement, etc. made without departing from the spirit and principle of this specification shall fall within the scope of the claims of this specification.

1. A system for privacy protection, wherein the system is applied to a blockchain and comprises a first terminal, a second terminal, and a consensus node, wherein:
the first terminal is configured to:
determine first service data of a to-be-executed service;
perform homomorphic encryption on the first service data to obtain first ciphertext, wherein the first ciphertext is used to execute the to-be-executed service;
encrypt the first service data based on a public key of the second terminal to obtain second ciphertext; and
generate a first zero-knowledge proof proving that the second ciphertext matches the first service data;
construct a service data packet based on the first ciphertext, the second ciphertext, and the first zero-knowledge proof; and
send the service data packet to the consensus node;
the consensus node is configured to:
receive the service data packet; and
perform consensus on the to-be-executed service based on the service data packet; and
the second terminal is configured to:
obtain, from the blockchain in response to a query operation, the service data packet obtained after the to-be-executed service has passed consensus; and
decrypt the second ciphertext in the service data packet based on a private key of the second terminal to determine the first service data.

2. The system according to claim 1, wherein:
the system further comprises a supervisory node;
the first terminal is configured to:
encrypt the first service data based on a public key of the supervisory node to obtain third ciphertext;
generate a fourth zero-knowledge proof proving that the third ciphertext matches the first service data; and
construct the service data packet based on the first ciphertext, the second ciphertext, the third ciphertext, the first zero-knowledge proof, and the fourth zero-knowledge proof; and
the supervisory node is configured to:
receive the service data packet; and
decrypt the third ciphertext in the service data packet based on a private key of the supervisory node to determine the first service data; and determine a risk control policy for the to-be-executed service based on the first service data.

3. The system according to claim 1, wherein:
the first terminal is an issuing institution terminal;
the second terminal is configured to send, in response to a conversion operation, a conversion request comprising the first service data to the issuing institution terminal; and
the issuing institution terminal is configured to:
receive the conversion request;
determine the first service data based on the conversion request; and
monitor a consensus result of the consensus node; and
after it is determined that the consensus result of the consensus node is that the consensus succeeds, update service data of an issuing institution account of the second terminal based on the first service data; and
push updated service data of the issuing institution account of the second terminal to the second terminal.

4. The system according to claim 3, wherein:
the system further comprises a supervisory node;
the issuing institution terminal is configured to:
encrypt the first service data based on a public key of the supervisory node to obtain fourth ciphertext;
generate a fifth zero-knowledge proof proving that the fourth ciphertext matches the first service data; and
construct the service data packet based on the first ciphertext, the second ciphertext, the fourth ciphertext, the first zero-knowledge proof, and the fifth zero-knowledge proof; and
the supervisory node is configured to:
receive the service data packet; and
decrypt the fourth ciphertext in the service data packet based on a private key of the supervisory node to determine the first service data; and
determine a risk control policy for the to-be-executed service based on the first service data.

5. The system according to claim 1, wherein:
the second terminal is configured to:
determine, based on the first service data, that execution of the to-be-executed service is completed; and
determine, based on the to-be-executed service, second service data required by the first terminal to execute a subsequent task of the to-be-executed service; and
send the second service data to the first terminal; and
the first terminal is configured to:
receive the second service request; and
execute the subsequent task based on the second service data.

6. The system according to claim 1, wherein:
the first terminal is a user terminal; and
the user terminal is further configured to:
generate a second zero-knowledge proof proving that the first service data supports the to-be-executed service and a third zero-knowledge proof proving that service data of the user terminal supports execution of the to-be-executed service; and
construct the service data packet based on the first ciphertext, the second ciphertext, the first zero-knowledge proof, the second zero-knowledge proof, and the third zero-knowledge proof.

7. The system according to claim 1, wherein:
the first terminal is an issuing institution terminal; and
the issuing institution terminal is configured to:
generate a second zero-knowledge proof proving that the first service data supports the to-be-executed service; and
construct the service data packet based on the first ciphertext, the second ciphertext, the first zero-knowledge proof, and the second zero-knowledge proof.

8. The system according to claim 1, wherein the first terminal is configured to:
invoke a smart contract to verify the service data packet; and
in response to that the verification succeeds, send the service data packet to the consensus node by using the smart contract.

9. The system according to claim 8, wherein:
the first terminal is a user terminal; and
the user terminal is further configured to:
generate a second zero-knowledge proof proving that the first service data supports the to-be-executed service and a third zero-knowledge proof proving that service data of the user terminal supports execution of the to-be-executed service;
construct the service data packet based on the first ciphertext, the second ciphertext, the first zero-knowledge proof, the second zero-knowledge proof, and the third zero-knowledge proof;
invoke the smart contract to verify whether the first zero-knowledge proof, the second zero-knowledge proof, and the third zero-knowledge proof in the service data packet are valid; and
in response to determining that all succeeds in the verification, update the service data of the user terminal and service data of the second terminal based on the first ciphertext by using the smart contract.

10. The system according to claim 8, wherein:
the first terminal is an issuing institution terminal; and
the issuing institution terminal is configured to:
generate a second zero-knowledge proof proving that the first service data supports the to-be-executed service;
construct the service data packet based on the first ciphertext, the second ciphertext, the first zero-knowledge proof, and the second zero-knowledge proof;
invoke the smart contract to verify the first zero-knowledge proof and the second zero-knowledge proof in the service data packet; and
in response to that both succeeds in the verification, update service data of the second terminal based on the first ciphertext by using the smart contract.

11. A method for privacy protection, wherein the method is applied to a first terminal in a privacy protection system, the privacy protection system is applied to a blockchain, and the privacy protection system comprises the first terminal, a second terminal, and a consensus node, and the method comprises:
determining first service data of a to-be-executed service;
performing homomorphic encryption on the first service data to obtain first ciphertext, wherein the first ciphertext is used to execute the to-be-executed service;
encrypting the first service data based on a public key of the second terminal to obtain second ciphertext;
generating a first zero-knowledge proof proving that the second ciphertext matches the first service data;
constructing a service data packet based on the first ciphertext, the second ciphertext, and the first zero-knowledge proof; and
sending the service data packet to the consensus node.

12. The method according to claim 11, wherein the sending the service data packet to the consensus node comprises:
invoking a smart contract to verify the service data packet; and
sending, in response to that the verification succeeds, the service data packet to the consensus node by using the smart contract through the blockchain.

13. The method according to claim 12, wherein the first terminal is a user terminal;
the constructing a service data packet based on the first ciphertext, the second ciphertext, and the first zero-knowledge proof comprises:
generating a second zero-knowledge proof proving that the first service data supports the to-be-executed service and a third zero-knowledge proof proving that service data of the user terminal supports execution of the to-be-executed service; and
constructing the service data packet based on the first ciphertext, the second ciphertext, the first zero-knowledge proof, the second zero-knowledge proof, and the third zero-knowledge proof; and
the invoking a smart contract to verify the service data packet; and sending, in response to that the verification succeeds, the service data packet to the consensus node by using the smart contract comprise:
invoking the smart contract to verify whether the first zero-knowledge proof, the second zero-knowledge proof, and the third zero-knowledge proof in the service data packet are valid; and
in response to that all succeeds in the verification, updating the service data of the user terminal and service data of the second terminal based on the first ciphertext by using the smart contract; and
sending the service data packet to the consensus node.

14. The method according to claim 12, wherein the first terminal is an issuing institution terminal;
the constructing a service data packet based on the first ciphertext, the second ciphertext, and the first zero-knowledge proof comprises:
generating a second zero-knowledge proof proving that the first service data supports the to-be-executed service; and
constructing the service data packet based on the first ciphertext, the second ciphertext, the first zero-knowledge proof, and the second zero-knowledge proof; and
the invoking a smart contract to verify the service data packet; and sending, in response to that the verification succeeds, the service data packet to the consensus node by using the smart contract comprise:
invoking the smart contract to verify the first zero-knowledge proof and the second zero-knowledge proof in the service data packet; and
in response to that both succeeds in the verification, updating service data of the second terminal based on the first ciphertext by using the smart contract; and
sending the service data packet to the consensus node.

15. The method according to claim 11, wherein the first terminal is an issuing institution terminal; and
the determining first service data of a to-be-executed service comprises determining the first service data based on a received conversion request.

16. The method according to claim 15, wherein the method further comprises:
monitoring a consensus result of the consensus node; and
after it is determined that the consensus result of the consensus node is that consensus succeeds, updating service data of an issuing institution account of the second terminal based on the first service data; and
pushing updated service data of the issuing institution account of the second terminal to the second terminal.

17. The method according to claim 11, wherein the first terminal is a user terminal; and
the constructing a service data packet based on the first ciphertext, the second ciphertext, and the first zero-knowledge proof comprises:
generating a second zero-knowledge proof proving that the first service data supports the to-be-executed service and a third zero-knowledge proof proving that service data of the user terminal supports execution of the to-be-executed service; and
constructing the service data packet based on the first ciphertext, the second ciphertext, the first zero-knowledge proof, the second zero-knowledge proof, and the third zero-knowledge proof.

18. The method according to claim 11, wherein the first terminal is an issuing institution terminal; and
the constructing a service data packet based on the first ciphertext, the second ciphertext, and the first zero-knowledge proof comprises:
generating a second zero-knowledge proof proving that the first service data supports the to-be-executed service; and
constructing the service data packet based on the first ciphertext, the second ciphertext, the first zero-knowledge proof, and the second zero-knowledge proof.

19. A method for privacy protection, wherein the method is applied to a second terminal in a privacy protection system, the privacy protection system is applied to a blockchain, and the privacy protection system comprises a first terminal, the second terminal, and a consensus node, and the method comprises:
obtaining, from the blockchain in response to a query operation, a service data packet obtained after a to-be-executed service has passed consensus; and
decrypting second ciphertext in the service data packet based on a private key of the second terminal to determine first service data.

20. The method according to claim 19, wherein the method further comprises:
determining, based on the first service data, that execution of the to-be-executed service is completed;
determining, based on the to-be-executed service, second service data required by the first terminal to execute a subsequent task of the to-be-executed service; and
sending the second service data to the first terminal, wherein the subsequent task is executed based on the second service data.
